(19) United States
(12) Patent Application Publication
(10) Pub. No.: US 2017/0357120 A1
(43) Pub. Date: Dec. 14, 2017

(54) DISPLAY DEVICE AND METHOD OF MANUFACTURING THE SAME

(71) Applicant: Samsung Display Co. Ltd., Yongin-si (KR)

(72) Inventors: Kwang Hyun KIM, Gunpo-si (KR); Sang Jae KIM, Yongin-si (KR); Yun JANG, Seongnam-si (KR)

(21) Appl. No.: 15/467,645

(22) Filed: Mar. 23, 2017

(30) Foreign Application Priority Data
Jun. 8, 2016 (KR) 10-2016-0071235

(51) Int. Cl. G02F 1/13363; G02F 1/1339; G02F 1/1337; G02F 1/1335

(52) U.S. Cl. CPC G02F 1/13363; G02F 1/133528; G02F 1/1339; G02F 1/133707; G02F 1/13394; G02F 1/133514; G02F 1/133512; G02F 2413/13; G02F 2201/50; G02F 2201/123; G02F 2413/11; G02F 2413/02; G02F 2413/14; G02F 2413/12; G02F 2201/121

(57) ABSTRACT

A display device includes a first substrate and a second substrate which face each other, a first retarder which is disposed between the first substrate and the second substrate and is a positive C plate and a second retarder which is disposed on an outer side of the second substrate and is a negative biaxial film.

This application claims priority to Korean Patent Application No. 10-2016-0071235, filed on Jun. 8, 2016, and all the benefits accruing therefrom under 35 U.S.C. §119, the content of which in its entirety is herein incorporated by reference.

### BACKGROUND

### 1. Field

Exemplary embodiments of the invention relate to a display device.

### 2. Description of the Related Art

With a development of multimedia, an importance of a display device is increasing. Accordingly, various types of a display device such as a liquid crystal display (“LCD”) and an organic light-emitting display (“OLED”) are being used.

In particular, the LCD is one of the most widely used types of flat panel displays. Generally, the LCD includes a pair of substrates having field generating electrodes, such as pixel electrodes and a common electrode, and a liquid crystal layer interposed between the pair of substrates. In the LCD, voltages are respectively applied to field generating electrodes to generate an electric field in a liquid crystal layer. Accordingly, a direction of liquid crystal molecules of the liquid crystal layer is determined, and a polarization of incident light is controlled. As a result, a desired image is displayed on the LCD.

The LCD includes at least one polarizing media. The LCD displays a desired image or blocks unintended light by controlling a polarizing medium or a combination of polarizing media. Therefore, various combinations of various types of polarizing media may be applied to an LCD.

### SUMMARY

Exemplary embodiments of the invention provide a display device which prevents the leakage of light.

Exemplary embodiments of the invention also provide a display device which reduces process cost.

However, exemplary embodiments of the invention are not restricted to the one set forth herein. The above and other exemplary embodiments of the invention will become more apparent to one of ordinary skill in the art to which the invention pertains by referencing the detailed description of the invention given below.

According to an exemplary embodiment of the invention, there is provided a display device including a first substrate and a second substrate which face each other, a first retarder which is disposed between the first substrate and the second substrate and is a positive C plate, and a second retarder which is disposed on an outer side of the second substrate and is a negative biaxial film.

In an exemplary embodiment, a first polarizing layer may be disposed on an outer side of the first substrate, and a protective film having a retardation value of zero may be disposed between the first polarizing layer and the first substrate.

In an exemplary embodiment, the display device may further include a common electrode which is disposed on the first substrate, and a pixel electrode in which a plurality of slits overlapping the common electrode is defined.

In an exemplary embodiment, the display device may further include a color filter which is disposed between the common electrode and the first substrate.

In an exemplary embodiment, the display device may further include a black matrix which is disposed on the first substrate, and a column spacer which extends from the black matrix.

In an exemplary embodiment, the display device may further include a black matrix and a color filter which are disposed on the second substrate.

In an exemplary embodiment, the black matrix and the color filter may be disposed between the first retarder and the second substrate.

In an exemplary embodiment, the first retarder may be a single layer and directly contact the second substrate.

In an exemplary embodiment, a retardation value of the first retarder in a plane direction may be about 10 millimeters (mm) or less.

In an exemplary embodiment, a retardation value of the first retarder in a thickness direction may be about 90 mm to about 120 mm.

In an exemplary embodiment, a retardation value of the second retarder in the plane direction may be about 80 mm to about 140 mm.

In an exemplary embodiment, a retardation value of the second retarder in the thickness direction may be about 40 mm to about 170 mm.

In an exemplary embodiment, a display area and a non-display area may be defined in the first substrate, and a seal pattern which bonds the first substrate and the second substrate together may be disposed in the non-display area, where the first retarder does not overlap the seal pattern.

According to another exemplary embodiment of the invention, there is provided a method of manufacturing a display device by bonding a first substrate and a second substrate together. The method includes forming a first retarder, which is a positive C plate, on a side of the second substrate, forming a second retarder, which is a negative biaxial film, on an opposite side of the second substrate, and placing the first substrate and the second substrate to face each other and then bonding the first substrate and the second substrate together.

In an exemplary embodiment, a common electrode and a pixel electrode in which a plurality of slits which overlap the common electrode is defined may be placed on the first substrate.

In an exemplary embodiment, the first retarder may be a single layer and may directly contact the second substrate.

### BRIEF DESCRIPTION OF THE DRAWINGS

These and/or other exemplary embodiments will become apparent and more readily appreciated from the following description of the exemplary embodiments, taken in conjunction with the accompanying drawings in which:

FIG. 1 is a plan view of an exemplary embodiment of a display device according to the invention;

FIG. 2 is a cross-sectional view of a portion of FIG. 1;

FIG. 3 is a cross-sectional view taken along line I-I′ of FIG. 1;

FIG. 4 is a partial cross-sectional view of an exemplary embodiment of a display device according to the invention;

FIG. 5 is a partial cross-sectional view of an exemplary embodiment of a display device according to the invention;

FIG. 6 is a cross-sectional view illustrating an exemplary embodiment of a method of manufacturing a display device according to the invention;

FIG. 7 is a cross-sectional view illustrating the exemplary embodiment of the method of manufacturing a display device according to the invention;

FIG. 8 is a cross-sectional view illustrating the exemplary embodiment of the method of manufacturing a display device according to the invention; and

FIG. 9 is a cross-sectional view illustrating the exemplary embodiment of the method of manufacturing a display device according to the invention.

### DETAILED DESCRIPTION

The exemplary embodiments and features of the invention and methods for achieving the exemplary embodiments and features will be apparent by referring to the exemplary embodiments to be described in detail with reference to the accompanying drawings. However, the invention is not limited to the exemplary embodiments disclosed hereinafter, but can be implemented in diverse forms. The matters defined in the description, such as the detailed construction and elements, are nothing but specific details provided to assist those of ordinary skill in the art in a comprehensive understanding of the invention, and the invention is only defined within the scope of the appended claims.

The term “on” that is used to designate that an element is on another element or located on a different layer or a layer includes both a case where an element is located directly on another element or a layer and a case where an element is located on another element via another layer or still another element. In the entire description of the invention, the same drawing reference numerals are used for the same elements across various figures.

It will be understood that when an element is referred to as being “on” another element, it can be directly on the other element or intervening elements may be therebetween. In contrast, when an element is referred to as being “directly on” another element, there are no intervening elements present.

Although the terms “first, second, and so forth” are used to describe diverse constituent elements, such constituent elements are not limited by the terms. The terms are used only to discriminate a constituent element from other constituent elements. Accordingly, in the following description, a first constituent element may be a second constituent element. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. In an exemplary embodiment, when the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, when the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the invention, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. In an exemplary embodiment, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims.

Hereinafter, exemplary embodiments of the invention will be described with reference to the attached drawings.

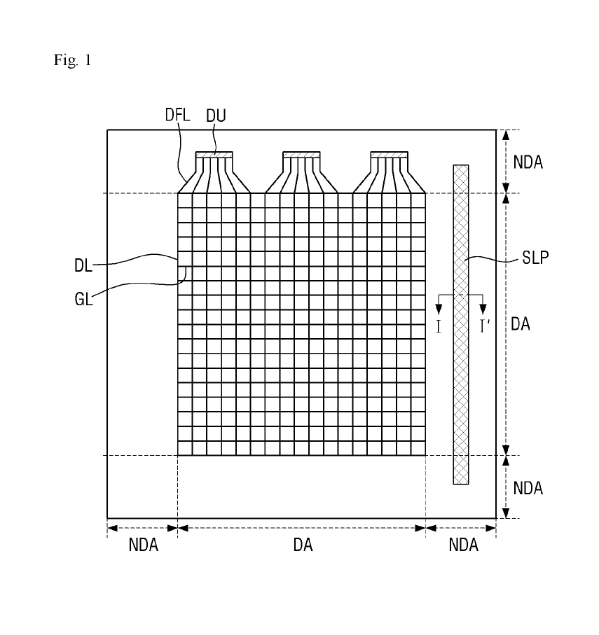

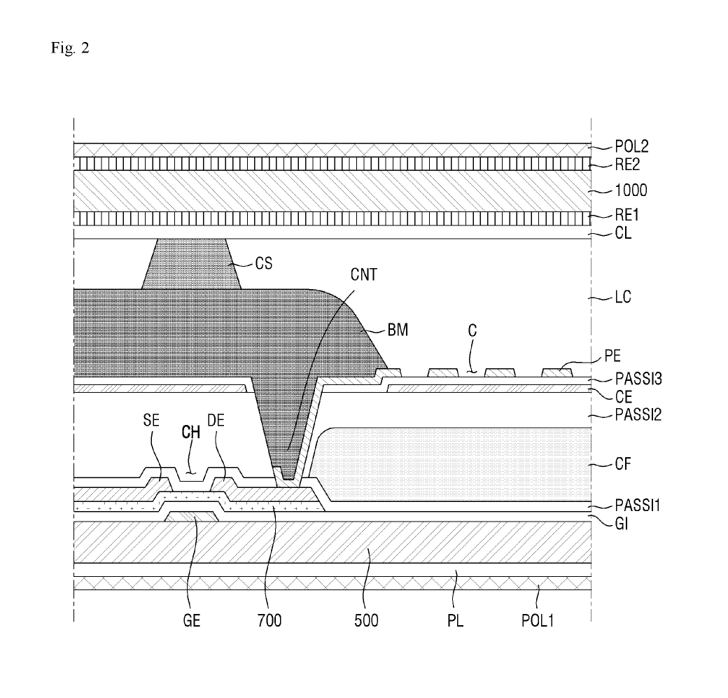

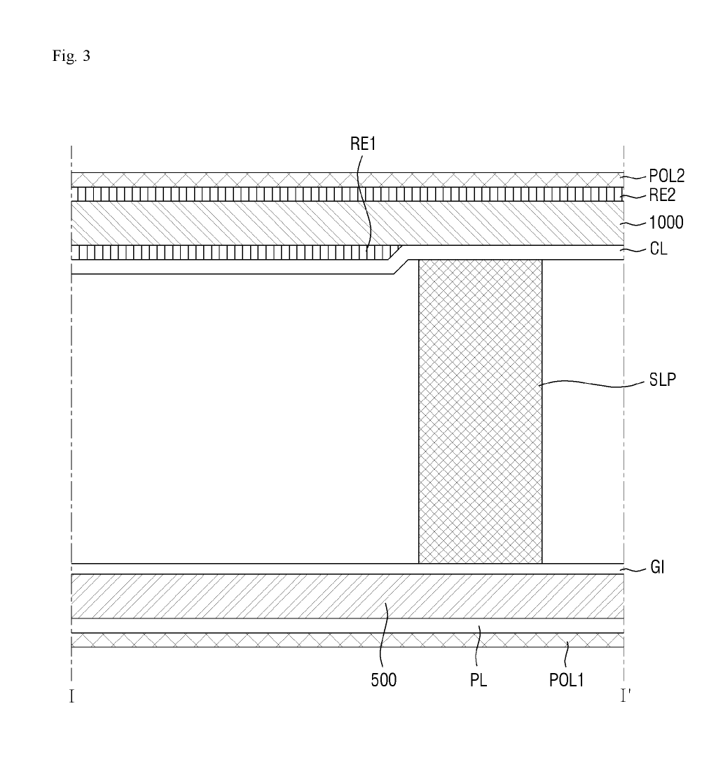

FIG. 1 is a plan view of a display device according to an exemplary embodiment. FIG. 2 is a cross-sectional view of a portion of FIG. 1. FIG. 3 is a cross-sectional view taken along line I-I′ of FIG. 1.

Referring to FIGS. 1 through 3, the display device according to the exemplary embodiment includes a first substrate 500 and a second substrate 1000 which face each other, a first retarder RE1 which is disposed between the first substrate 500 and the second substrate 1000 and is a positive C plate, and a second retarder RE2 which is disposed on an outer side of the second substrate 1000 and is a negative biaxial film.

The first substrate 500 may include a material having heat-resisting and light-transmitting properties. In an exemplary embodiment, the first substrate 500 which is a lower substrate may include, but not limited to, transparent glass or plastic, for example. A display area DA and a non-display area NDA may be defined in the first substrate 500.

The display area DA is an area of the display device in which an image is displayed, and the non-display area NDA is an area in which various signal lines are disposed to enable the display area DA to display an image.

In the non-display area NDA, a plurality of data drivers DU which provide data signals to data lines DL and a plurality of data fan-out lines DFL which deliver signals received from the data drivers DU to the data lines DL may be disposed.

The display area DA will now be described in more detail. In the display area DA, a plurality of pixels defined at intersections of a plurality of data lines DL and a plurality of gate lines GL may be disposed.

FIG. 2 is a partial cross-sectional view of a pixel of FIG. 1. The display device according to the exemplary embodiment will be continuously described with reference to FIG. 2.

A first polarizing layer POL1 may be disposed on an outer side of the first substrate 500. The first polarizing layer POL1 may polarize light emitted from a backlight unit (not illustrated) disposed outside the first substrate 500. Specifically, of light emitted from the backlight unit, the first polarizing layer POL1 may transmit a portion of light oscillating in a predetermined direction and absorb or reflect other portions of light.

In an exemplary embodiment, the first polarizing layer POL1 may be a polarizing film adsorbed with polymer resin which is stretched in a predetermined direction and a light-absorbing material which absorbs light oscillating in a predetermined direction. In an exemplary embodiment, the first polarizing layer POL1 may include a metal layer and absorb or reflect some light while transmitting some light, for example. In an exemplary embodiment, the first polarizing layer POL1 may be a polarizing layer to which a wire grid polarizer (“WGP”) has been applied, for example.

A protective film PL may be disposed on the polarizing layer POL1. That is, as illustrated in FIG. 2, the protective film PL may be disposed between the first polarizing layer POL1 and the first substrate 500.

The protective film PL may protect the first polarizing layer POL1. In an exemplary embodiment, a retardation value of the protective film PL may be zero (0) in order not to affect light that transmits through the first polarizing layer POL1.

A gate wiring layer (GL and GE) may be disposed on the first substrate 500. The gate wiring layer (GL and GE) may include a gate line GL which receives a driving signal and a gate electrode GE which protrudes from the gate line GL. The gate line GL may extend in a first direction. The first direction may be, for example, a horizontal direction in FIG. 1. The gate electrode GE may provide three terminals of a thin-film transistor (“TFT”) together with a source electrode SE and a drain electrode DE which will be described later.

In an exemplary embodiment, the gate wiring layer (GL and GE) may include at least one of aluminum (Al)-based metal such as an aluminum alloy, silver (Ag)-based metal such as a silver alloy, copper (Cu)-based metal such as a copper alloy, molybdenum (Mo)-based metal such as a molybdenum alloy, chrome (Cr), titanium (Ti), and tantalum (Ta), for example. However, the above materials are merely examples, and the material that forms the gate wiring layer (GL and GE) is not limited to these materials. A metallic or polymer material having performance desired to implement a desired display device may also be used to provide the gate wiring layer (GL and GE).

The gate wiring layer (GL and GE) may have a single layer structure. However, the structure of the gate wiring layer (GL and GE) is not limited to the single layer structure, and the gate wiring layer (GL and GE) may also have a multilayer structure such as a double layer structure or a triple or more layer structure.

A gate insulating layer GI may be disposed on the gate wiring layer (GL and GE). The gate insulating layer GI may cover the gate wiring layer (GL and GE) and may be disposed on the whole surface of the first substrate 500.

In an exemplary embodiment, the gate insulating layer GI may include at least one of inorganic insulating materials such as silicon oxide (SiOx) and silicon nitride (SiNx) and organic insulating materials such as benzocyclobutene (“BCB”), an acrylic material and polyimide. However, the above materials are merely examples, and the material of the gate insulating layer GI is not limited to the above materials.

A semiconductor pattern layer 700 may be disposed on the gate insulating layer GI.

In an exemplary embodiment, the semiconductor pattern layer 700 may include amorphous silicon or polycrystalline silicon, for example. However, the material of the semiconductor pattern layer 700 is not limited to the above materials, and the semiconductor pattern layer 700 may also include an oxide semiconductor, for example.

In exemplary embodiments, the semiconductor pattern layer 700 may have various shapes such as an island shape and a linear shape. When the semiconductor pattern layer 700 has a linear shape, the semiconductor pattern layer 700 may be disposed under a data line DL and extend onto the gate electrode GE.

In an exemplary embodiment, the semiconductor pattern layer 700 may be patterned in substantially the same shape as a data wiring layer (DL, SE and DE) in all areas excluding a channel region CH.

In other words, the semiconductor pattern layer 700 may overlap the data wiring layer (DL, SE and DE) in all areas excluding the channel region CH.

The channel region CH may be disposed between the source electrode SE and the drain electrode DE which face each other. The channel region CH may electrically connect the source electrode SE and the drain electrode DE, and a shape of the channel region CH is not limited to a particular shape.

An ohmic contact layer (not illustrated) heavily doped with an n-type impurity may be disposed on the semiconductor pattern layer 700. The ohmic contact layer may overlap the whole or part of the semiconductor pattern layer 700. However, in an exemplary embodiment in which the semiconductor pattern layer 700 includes an oxide semiconductor, the ohmic contact layer may be omitted.

When the semiconductor pattern layer 700 is an oxide semiconductor, the semiconductor pattern layer 700 may include zinc oxide (ZnO), for example. In an exemplary embodiment, the semiconductor pattern layer 700 may be doped with at least one ion of gallium (Ga), indium (In), stannum (Sn), zirconium (Zr), hafnium (Hf), cadmium (Cd), silver (Ag), copper (Cu), germanium (Ge), gadolinium (Gd), titanium (Ti), and vanadium (V), for example. In an exemplary embodiment, the semiconductor pattern layer 700 which is an oxide semiconductor may include at least one of ZnO, ZnGaO, ZnInO, ZnSnO, GaInZnO, CdO, InO, GaO, SnO, AgO, CuO, GeO, GdO, HfO, TiZnO, InGaZnO, and InTiZnO, for example. However, these are merely examples, and the type of the oxide semiconductor is not limited to the above examples.

In an exemplary embodiment, the semiconductor pattern layer 700 may include a low temperature polycrystalline silicon (“LTPS”) semiconductor, for example. That is, the invention is not limited to the type of a semiconductor included in the semiconductor pattern layer 700, and various types of semiconductors that are now being used or that will be used depending on future technological developments may be applied to the semiconductor pattern layer 700 of the invention.

The data wiring layer (DL, SE and DE) may be disposed on the semiconductor pattern layer 700. The data wiring layer (DL, SE and DE) includes the data line DL, the source electrode SE, and the drain electrode DE.

The data line DL may extend in a second direction, for example, in a vertical direction in FIG. 1 and intersect the gate line GL.

The source electrode SE may branch off from the data line DL and extend onto the semiconductor pattern layer 700.

The drain electrode DE may be separated from the source electrode SE and may be disposed on the semiconductor pattern layer 700 to face the source electrode SE with respect to the gate electrode GE or the channel region CH. The drain electrode DE may contact a pixel electrode PE which will be described later. Thus, the drain electrode DE may be electrically connected to the pixel electrode PE.

In an exemplary embodiment, the data wiring layer (DL, SE and DE) may have a single layer structure or a multilayer structure including at least one of nickel (Ni), cobalt (Co), titanium (Ti), silver (Ag), copper (Cu), molybdenum (Mo), aluminum (Al), beryllium (Be), niobium (Nb), gold (Au), iron (Fe), selenium (Se), and tantalum (Ta), for example. In an exemplary embodiment, the data wiring layer (DL, SE and DE) may include an alloy of any one of the above metals and at least one element of titanium (Ti), zirconium (Zr), tungsten (W), tantalum (Ta), niobium (Nb), platinum (Pt), hafnium (Hf), oxygen (O), and nitrogen (N), for example. However, the above materials are merely examples, and the material of the data wiring layer (DL, SE and DE) is not limited to the above materials.

In FIG. 2, a case where one TFT is disposed in one pixel is illustrated. However, the scope of the invention is not limited to this case. That is, in an exemplary embodiment, the number of TFTs disposed in one pixel may be more than one. In addition, when a plurality of TFTs is disposed in one pixel, the pixel may be divided into a plurality of domains respectively corresponding to the TFTs.

A first passivation layer PASSI1 may be disposed on the data wiring layer (DL, SE and DE) and the semiconductor pattern layer 700. The first passivation layer PASSI1 may include an inorganic insulating material or an organic insulating material.

A color filter CF may be disposed on the first passivation layer PASSI1. That is, the display device according to the exemplary embodiment may be a color filter-on-array (“COA”) display device in which the color filter CF is disposed on the first substrate 500, for example. In an exemplary embodiment, the color filter CF may include at least one of a blue color filter, a green color filter and a red color filter, for example. However, the invention is not limited thereto, and the color filter CF may include various other color filters. In an exemplary embodiment, the blue color filter, the green color filter, and the red color filter may have different heights from one another.

The color filter CF may at least partially overlap or may not overlap the drain electrode DE.

A second passivation layer PASSI2 may be disposed on the color filter CF. As a planarization layer, the second passivation layer PASSI2 may cover the first passivation layer PASSI1 and the color filter CF. The second passivation layer PASSI2 may include an inorganic insulating material or an organic insulating material.

A common electrode CE may be disposed on the second passivation layer PASSI2. A common voltage may be applied to the common electrode CE.

A third passivation layer PASSI3 may be disposed on the common electrode CE. The third passivation layer PASSI3 may insulate the pixel electrode PE which will be described later from the common electrode CE.

A contact hole CNT may be defined in the first passivation layer PASSI1, the second passivation layer PASSI2 and the third passivation layer PASSI3 to pass through the first passivation layer PASSI1, the second passivation layer PASSI2 and the third passivation layer PASSI3. The contact hole CNT may pass through the first passivation layer PASSI1, the second passivation layer PASSI2 and the third passivation layer PASSI3 to expose a part of the drain electrode DE.

The pixel electrode PE may be disposed on the third passivation layer PASSI3 and the contact hole CNT. The pixel electrode PE may at least partially fill the contact hole CNT and may be electrically connected to the drain electrode DE via the contact hole CNT.

In an exemplary embodiment, the pixel electrode PE may be a transparent electrode and may include a transparent conductor such as indium tin oxide (“ITO”) or indium zinc oxide (“IZO”) or a reflective conductor such as aluminum.

A plurality of slits C may be defined in the pixel electrode PE. The slits C of the pixel electrode PE may overlap the common electrode CE, and an electric field may be generated between the pixel electrode PE and the common electrode CE through the slits C.

The electric field generated between the pixel electrode PE and the common electrode CE through the slits C may control the movement of liquid crystal molecules existing in a liquid crystal layer LC disposed between the first substrate 500 and the second substrate 1000.

That is, the display device according to the exemplary embodiment may be a lateral electric field display device, in other words, a plane line switching (“PLS”) display device, for example.

A black matrix BM may be disposed on the third passivation layer PASSI3 and the pixel electrode PE. That is, the display device according to the exemplary embodiment may be a black matrix-on-array (“BOA”) display device in which the black matrix BM is disposed on the first substrate 500, for example.

The black matrix BM may cover the TFT. In addition, the black matrix BM may extend along the data line DL and/or the gate line GL.

The black matrix BM may block light incident from an external source. To this end, the black matrix BM may include photosensitive resin that includes a black pigment. However, this is merely an example, and the material of the black matrix BM is not limited to the above material. The black matrix BM may include any material that has physical properties needed to block light incident from an external source.

A column spacer CS may be disposed on the black matrix BM. In an exemplary embodiment, the column spacer CS may be unitary with the black matrix BM. That is, the display device according to the exemplary embodiment may be a black column spacer (“BCS”) display device in which the column spacer CS and the black matrix BM are unitary with each other on the first substrate 500, for example.

The second substrate 1000 may face the first substrate 500. A capping layer CL may be disposed between the second substrate 1000 and the column spacer CS. That is, the capping layer CL may directly contact the column spacer CS.

The first retarder RE1 may be disposed between the capping layer CL and the second substrate 1000.

The first retarder RE1 may retard the phase of light that passes through the first polarizing layer POL1. That is, the first retarder RE1 may correct light that passes through the liquid crystal layer LC, thereby preventing the leakage of light in the display device. That is, the first retarder RE1 may reduce the leakage of light in a diagonal direction by compensating for a break in orthogonality of polarization in the diagonal direction.

For a detailed description of the first retarder RE1, some terms will be described below.

A retarder, that is, a retardation film is classified into a uniaxial film and a biaxial film according to the number of optical axes and also classified into a positive film and a negative film according to a difference between a refractive index in an optical axis direction and refractive indices in other directions. In an exemplary embodiment, the retardation film is classified into a uniaxial film when there is a single optical axis and into a biaxial film when there are two optical axes, for example. In addition, the retardation film is classified into a positive film when the refractive index in the direction of the optical axis is greater than the refractive indexes in the other directions, and into a negative film when the refractive index in the direction of the optical axis is smaller than the refractive indexes in the other directions.

The retardation film may be expressed by a refractive index in each direction in a xyz coordinate system. When the retardation film is disposed on a xy plane, for example, the x-axis and the y-axis denote plane directions of the retardation film, and the z-axis denotes a thickness direction of the retardation film.

That is, the retardation film has refractive indexes nx, ny and nz according to the x-, y- and z-axes, respectively.

Here, Re represents a retardation value in the plane direction, and Rth represents a retardation value in the thickness direction. Also, Nz represents the extent of biaxiality of the biaxial retardation film.

The above description may be summarized as in following Equation (1):

Re=(nx−ny)*d

Rth=((nx+ny)/2−nz)*d

Nz=Rth/Re, (1)

where d is a thickness of a film.

According to Equation (1), the first retarder RE1 may be a positive C plate. In other words, the first retarder RE1 may have a refractive index relation of nz>nx=ny.

In an exemplary embodiment, the retardation value Re of the first retarder RE in the plane direction may be about 10 millimeters (mm) or less. In an exemplary embodiment, the retardation value Rth of the first retarder RE1 in the thickness direction may be about 90 mm to about 210 mm.

In an exemplary embodiment, the first retarder RE1 may be a single layer. In an exemplary embodiment, the first retarder RE1 provided as a single layer may directly contact the second substrate 1000.

The second substrate 1000 may be disposed on the first retarder RE1. The second substrate 1000 may include a material having heat-resisting and light-transmitting properties. In an exemplary embodiment, the second substrate 1000 which is an upper substrate may include, but not limited to, transparent glass or plastic, for example.

The second retarder RE2 may be disposed on the second substrate 1000, that is, on the outer side of the second substrate 1000.

The second retarder RE2 may be a negative biaxial film. That is, the second retarder RE2 may have a refractive index relation of nx>ny>nz. In an exemplary embodiment, the value of Nz of the second retarder RE2 may be greater than 1.0, for example.

In an exemplary embodiment, the retardation value Re of the second retarder RE2 in the plane direction may be about 80 mm to about 140 mm, for example. In an exemplary embodiment, the retardation value Rth of the second retarder RE2 in the thickness direction may be about 40 mm to about 170 mm, for example.

In a lateral electric field display device, when the first retarder RE1 and the second retarder RE2 having the above optical characteristics are combined, the leakage of light in the diagonal direction may be noticeably reduced.

In addition, when at least some of a plurality of retarders are disposed between the first substrate 500 and the second substrate 1000, a process efficiency is improved, thereby reducing process cost.

A second polarizing layer POL2 may be disposed on the second retarder RE2.

An oscillation direction of light transmitted by the second polarizing layer POL2 may be the same or different from an oscillation direction of light transmitted by the first polarizing layer POL1. In an exemplary embodiment in which the first polarizing layer POL1 transmits light oscillating in a first direction, the second polarizing layer POL2 may transmit light oscillating in the first direction or light oscillating in a second direction (e.g., a direction perpendicular to the first direction) different from the first direction, for example.

In an exemplary embodiment, the second polarizing layer POL2 may be a polarizing film adsorbed with polymer resin which is stretched in a predetermined direction and a light-absorbing material which absorbs light oscillating in a predetermined direction. In an exemplary embodiment, the second polarizing layer POL2 may include a metal layer and absorb or reflect some light while transmitting some light. In an exemplary embodiment, the second polarizing layer POL2 may be a polarizing layer to which a WGP has been applied.

The non-display area NDA of the display device according to the exemplary embodiment will now be described in more detail with reference to FIG. 3.

As illustrated in FIG. 1, a seal pattern SLP for bonding the first substrate 500 and the second substrate 1000 together may be disposed in the non-display area NDA. In FIG. 1, the seal pattern SLP is disposed only on a side of the non-display area NDA. However, this is merely an example used for ease of description, and the placement of the seal pattern SLP is not limited to this example. That is, in an exemplary embodiment, the seal pattern SLP may be disposed along the non-display area NDA to form a closed figure, or a plurality of seal patterns SLP may be separated from each other.

Referring to FIG. 3, the capping layer CL may be disposed on the whole surface of the second substrate 1000. In other words, the capping layer CL may be provided all over the display area DA and the non-display area NDA.

The first retarder RE1 may be disposed in the display area DA and a part of the non-display area NDA.

In other words, the first retarder RE1 may not overlap the seal pattern SLP disposed in the non-display area NDA. Due to material or structural characteristics of the seal pattern SLP, the first retarder RE1 may reduce adhesive strength of the seal pattern SLP. When the first retarder RE1 does not overlap the seal pattern SLP disposed in the non-display area NDA, the adhesion between the first substrate 500 and the second substrate 1000 is improved.

Display devices according to other exemplary embodiments will now be described. In the following exemplary embodiments, elements substantially identical to those described above are indicated by like reference numerals, and thus their description will be omitted or given briefly.

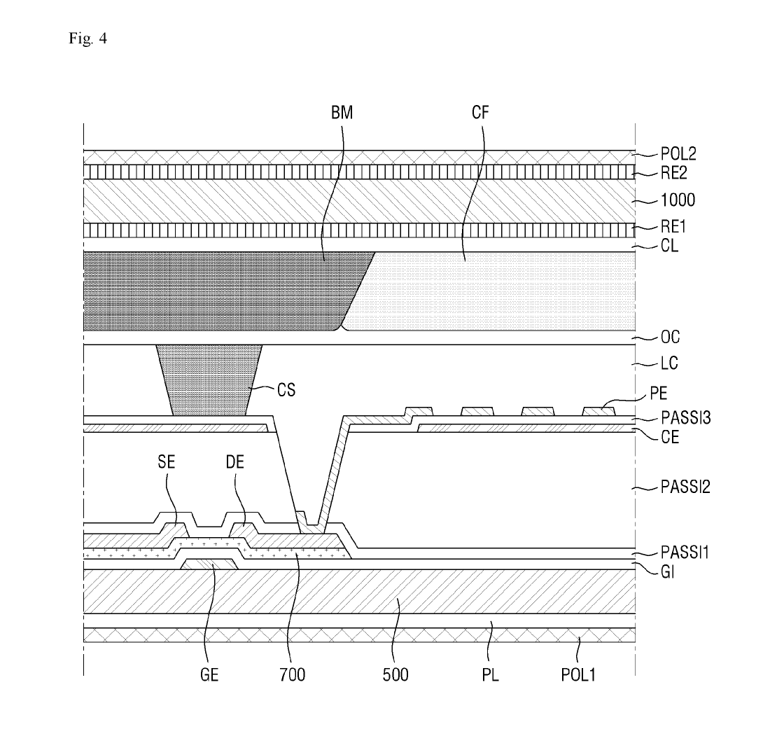

FIG. 4 is a partial cross-sectional view of a display device according to an exemplary embodiment.

Referring to FIG. 4, the display device according to the exemplary embodiment is different from the display device according to the exemplary embodiment of FIG. 2 in that a black matrix BM and a color filter CF are disposed on a second substrate 1000.

In an exemplary embodiment, the black matrix BM and the color filter CF may be disposed on the second substrate 1000. The black matrix BM and the color filter CF may be covered by an overcoat layer OC which is a planarization layer.

A column spacer CS may be disposed between the overcoat layer OC and a third passivation layer PASSI3. That is, in an exemplary embodiment, an upper surface of the column spacer CS may directly contact the overcoat layer OC, and a lower surface of the column spacer CS may directly contact the third passivation layer PASSI3.

Elements disposed on a first substrate 500 may be substantially identical to those described above with reference to FIG. 2, except for the color filter CF. Thus, a detailed description of the elements is omitted.

A capping layer CL may be disposed between the black matrix BM and the color filter CF and a first retarder RE1.

The first retarder RE1, the second substrate 1000, a second retarder RE2 and a second polarizing layer POL2 may be disposed on the capping layer CL. The first retarder RE1, the second substrate 1000, the second retarder RE2, and the second polarizing layer POL2 may be substantially identical to those described above with reference to FIG. 2. Thus, a detailed description of the elements is omitted.

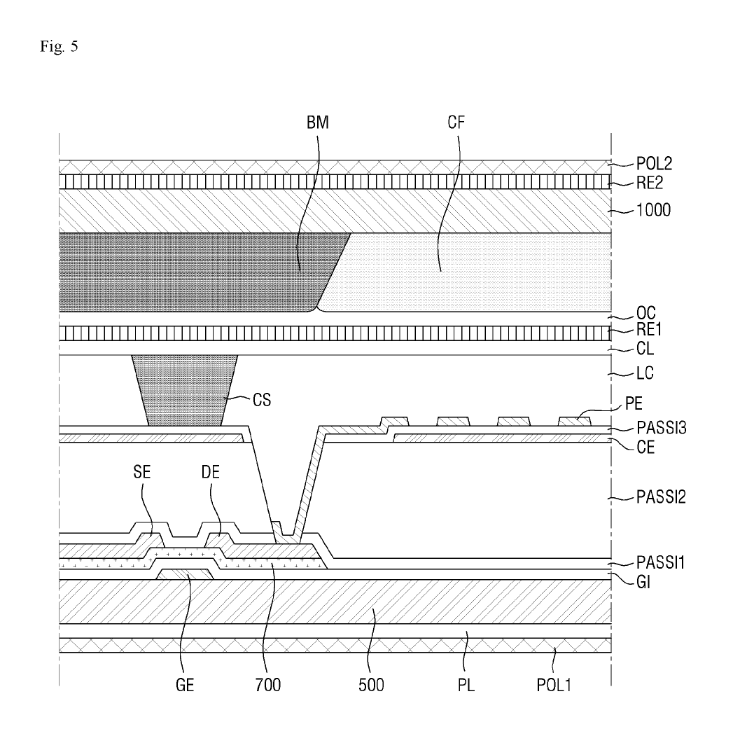

FIG. 5 is a partial cross-sectional view of a display device according to an exemplary embodiment.

Referring to FIG. 5, the display device according to the exemplary embodiment is different from the display device according to the exemplary embodiment of FIG. 4 in that a black matrix BM and a color filter CF are disposed between a second substrate 1000 and a capping layer CL.

Specifically, a column spacer CS may be disposed on a third passivation layer PASSI3 on a first substrate 500. The capping layer CL may be disposed on the column spacer CS. In an exemplary embodiment, the capping layer CL may directly contact the column spacer CS.

A first retarder RE1 may be disposed on the capping layer CL. An overcoat layer OC may be disposed on the first retarder RE1. The black matrix BM and the color filter CF may be disposed on the overcoat layer OC. That is, as a planarization layer, the overcoat layer OC may cover the black matrix BM and the color filter CF.

That is, in the exemplary embodiment of FIG. 5, the black matrix BM, the color filter CF and the second substrate 1000 may be disposed between the first retarder RE1 and a second retarder RE2.

A method of manufacturing a display device according to exemplary embodiments will now be described. Some elements described below may be identical to those of the liquid crystal displays (“LCDs”) according to the above-described exemplary embodiments, and some elements will not be described to avoid redundancy in description.

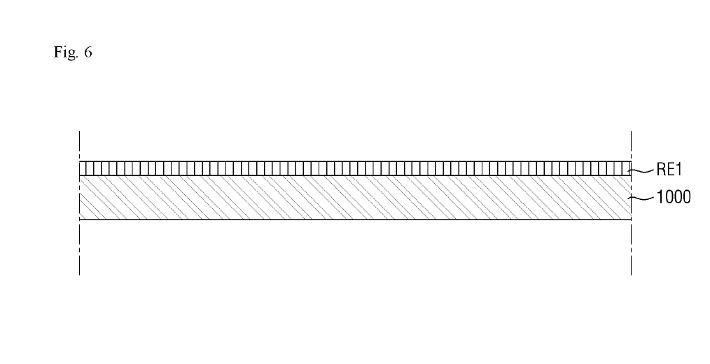

FIGS. 6 through 9 are cross-sectional views illustrating a method of manufacturing a display device according to an exemplary embodiment.

Referring to FIGS. 6 through 9, the method of forming a display device according to the exemplary embodiment includes forming a first retarder RE1 on a side of a second substrate 1000, forming a second retarder RE2, which is a negative biaxial film, on the other side of the second substrate 1000, and bonding a first substrate 500 and the second substrate 1000 together by placing the first substrate 500 and the second substrate 1000 to face each other.

First, the first retarder RE1, which is a positive C plate, is disposed on the second substrate 1000, i.e., an upper substrate. In an exemplary embodiment, the first retarder RE1 may be provided using at least one of slit coating, inkjet coating, and gravure coating, for example. The first retarder RE1 may be identical to those of the display devices according to the above-described exemplary embodiments. Therefore, a detailed description of the first retarder RE1 is omitted.

The first retarder RE1 may be disposed on the whole surface of the second substrate 1000 or on the whole surface of the second substrate 1000 excluding a part of a non-display area NDA (refer to FIG. 3).

The first retarder RE1 may be provided as a single layer and may directly contact the second substrate 1000.

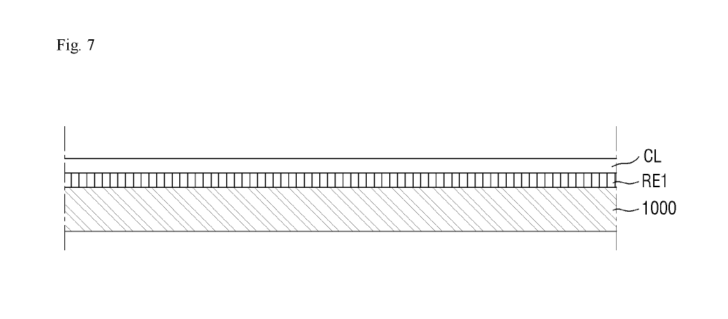

Referring to FIG. 7, a capping layer CL may be disposed on the first retarder RE1. The capping layer CL may be disposed on the whole surface of the second substrate 1000 to cover the whole surface of the first retarder RE1.

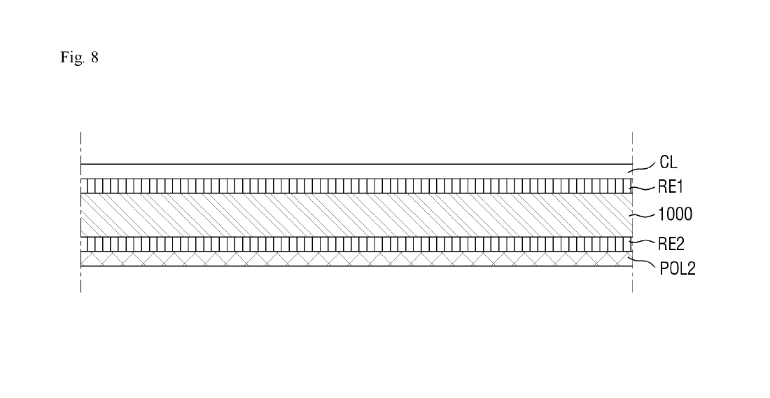

Referring to FIG. 8, the second retarder RE2 is disposed on the other side of the second substrate 1000. When the second retarder RE2 is provided, the second substrate 1000 may be disposed between the first retarder RE1 and the second retarder RE2.

Next, a second polarizing layer POL2 may be disposed on the second retarder RE2. The second polarizing layer POL2 may be provided as a single layer or a multilayer.

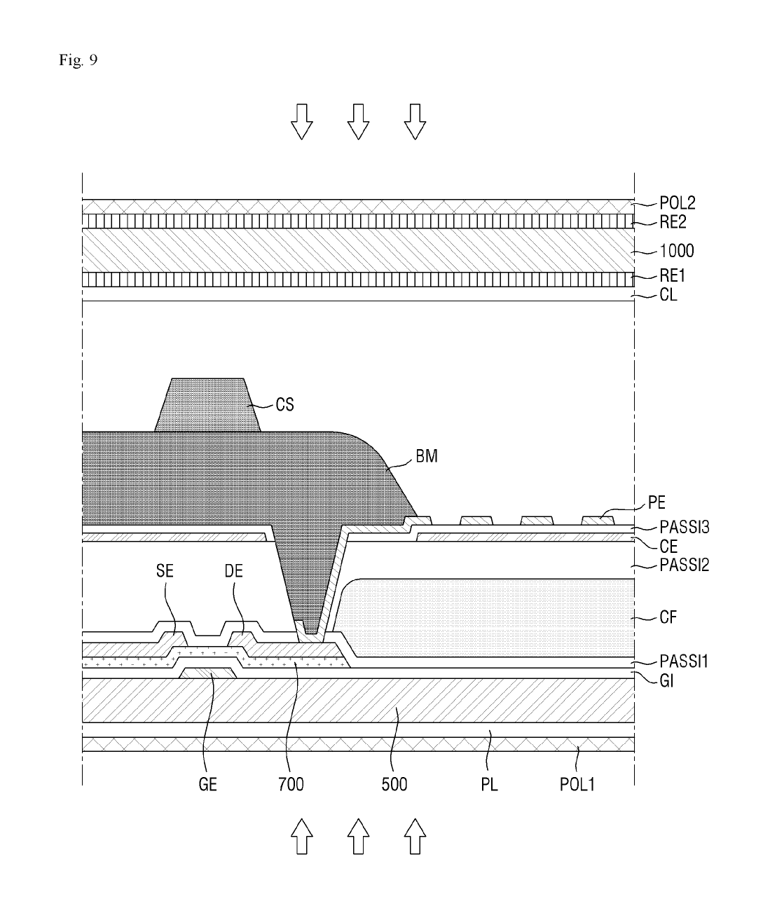

Referring to FIG. 9, the first substrate 500 and the second substrate 1000 may be bonded together. The first substrate 500 may be substantially identical to those of the display devices according to the above-described exemplary embodiments. Accordingly, various elements disposed on the first substrate 500 may also be substantially identical to those of the display devices according to the above-described exemplary embodiments.

A seal pattern SLP may be defined between the first substrate 500 and the second substrate 1000 (refer to FIGS. 1 and 3), and the first substrate 500 and the second substrate 1000 may be bonded together by the seal pattern SLP.

In the above exemplary embodiment, a case where the second polarizing layer POL2 is provided before the first substrate 500 and the second substrate 1000 are bonded together. However, in an exemplary embodiment, the second polarizing layer POL2 may also be provided after the first substrate 500 and the second substrate 1000 are bonded together. The same applies to a first polarizing layer POL1 disposed on an outer side of the first substrate 500.

Exemplary embodiments of the invention provide at least one of the following advantages.

The leakage of light of a display device is prevented.

The manufacturing cost of a display device is saved.

However, the effects of the invention are not restricted to the one set forth herein. The above and other effects of the invention will become more apparent to one of daily skill in the art to which the invention pertains by referencing the claims.

While the invention has been particularly illustrated and described with reference to exemplary embodiments thereof, it will be understood by those of ordinary skill in the art that various changes in form and detail may be made therein without departing from the spirit and scope of the invention as defined by the following claims. The exemplary embodiments should be considered in a descriptive sense only and not for purposes of limitation.

What is claimed is:

1. A display device comprising:
a first substrate and a second substrate facing each other;
a first retarder which is disposed between the first substrate and the second substrate and is a positive C plate; and
a second retarder which is disposed on an outer side of the second substrate and is a negative biaxial film.

2. The display device of claim 1, further comprising:
a first polarizing layer disposed on an outer side of the first substrate; and
a protective film having a retardation value of zero and disposed between the first polarizing layer and the first substrate.

3. The display device of claim 1, further comprising:
a common electrode which is disposed on the first substrate; and
a pixel electrode in which a plurality of slits overlapping the common electrode is defined.

4. The display device of claim 3, further comprising a color filter which is disposed between the common electrode and the first substrate.

5. The display device of claim 1, further comprising:
a black matrix which is disposed on the first substrate; and
a column spacer which extends from the black matrix.

6. The display device of claim 1, further comprising a black matrix and a color filter which are disposed on the second substrate.

7. The display device of claim 6, wherein the black matrix and the color filter are disposed between the first retarder and the second substrate.

8. The display device of claim 1, wherein the first retarder is a single layer and directly contacts the second substrate.

9. The display device of claim 1, wherein a retardation value of the first retarder in a plane direction is 10 millimeters or less.

10. The display device of claim 1, wherein a retardation value of the first retarder in a thickness direction is 90 millimeters to 120 millimeters.

11. The display device of claim 1, wherein a retardation value of the second retarder in the plane direction is 80 millimeters to 140 millimeters.

12. The display device of claim 1, wherein a retardation value of the second retarder in the thickness direction is 40 millimeters to 170 millimeters.

13. The display device of claim 1, wherein
a display area and a non-display area are defined in the first substrate, and a seal pattern which bonds the first substrate and the second substrate together is disposed in the non-display area, and
the first retarder does not overlap the seal pattern.

14. A method of manufacturing a display device by bonding a first substrate and a second substrate together, the method comprising:
forming a first retarder, which is a positive C plate, on a side of the second substrate;
forming a second retarder, which is a negative biaxial film, on an opposite side of the second substrate; and
placing the first substrate and the second substrate to face each other and then bonding the first substrate and the second substrate together.

15. The method of claim 14, further comprising:
providing a common electrode on the first substrate; and
providing a pixel electrode, in which a plurality of slits overlapping the common electrode is defined, on the first substrate.

16. The method of claim 14, wherein the first retarder is a single layer and directly contacts the second substrate.
